(19) United States
(12) Patent Application Publication
(10) Pub. No.: US 2011/0055054 A1
(43) Pub. Date: Mar. 3, 2011

(54) METHOD FOR ONLINE SELECTION OF ITEMS AND AN ONLINE SHOPPING SYSTEM USING THE SAME

(75) Inventor: David William Glasson, New South Wales (AU)

(73) Assignee: INNOVATION STUDIOS PTY LTD, Double Bay New South Wales (AU)

(21) Appl. No.: 12/865,110

(22) PCT Filed: Jan. 30, 2009
(86) PCT No.: PCT/AU09/00112

§ 371 Date: Nov. 12, 2010

(30) Foreign Application Priority Data
Feb. 1, 2008 (AU) 2008900447

(51) Int. Cl. G06Q 30/00

(52) U.S. Cl. 705/27.2

(57) ABSTRACT

A method for facilitating an online selection of an item by a user is described. The item is selected out of a plurality of selection items of different sizes, the selection being based on a reference item located remotely from the plurality of selection items. The method is performed on an electronic system and starts with accessing data related to a first image of the reference item, and at least one known first reference measurement associated with the first image. Data is then accessed related to one or more second images of one or more selection items, and at least one known second reference measurement associated with each of the second images. The data associated with the first and second images is then processed so as to facilitate dimensional comparison of the reference item with at least one of the selection items. Finally, the user is enabled to visually compare at least one dimension of the at least one of the selection items, with a corresponding dimension of the reference item, the result of the comparison enabling the user to select an item out of the plurality of selection items.

### CROSS-REFERENCE TO RELATED PATENT APPLICATIONS

This application claims priority from Australian Provisional Patent Application No. 2008900447, filed on 1 Feb. 2008 in the name of Innovation Studios Pty Ltd, which is incorporated by reference herein in its entirety as if fully set forth herein.

### TECHNICAL FIELD

The present invention relates to a method and a system for online shopping, and in particular to a method and a system for enabling a user to choose a clothing item of a particular size, within an online shopping arrangement.

### BACKGROUND OF THE INVENTION

Buying clothes over the internet can be risky, since there is always the possibility that the clothes bought will not fit. This necessitates use of a “return” and “re-order” process, resulting in a waste of money and time. For people buying clothes or used clothes via internet sites, there is typically no refund policy and the buyer is either forced to throw away or attempt to resell the ill-fitting clothes. The process is made even more difficult by the lack of a universal standard for clothing sizes. For example a “small” size in Japan is different from a “small” size in the US, which in turn is different from the same size in Europe. In addition, discrepancies exist in sizing standards between different labels within a single country. For example, a “small” Calvin Klein shirt does not necessarily have the same fit as a “small” Hugo Boss shirt. Such issues have substantially hampered the expansion of online shopping for years.

### SUMMARY OF THE INVENTION

It is an object of the present invention to substantially overcome, or at least ameliorate, one or more disadvantages of existing arrangements or at least to offer a useful alternative.

According to one aspect of the invention, there is provided a method for facilitating online selection of an item by a user, the item being selected out of a plurality of selection items of different sizes, the selection being based on a reference item located remotely from the plurality of selection items, the method being performed on an electronic system and comprising the steps of;

a) accessing data related to a first image of the reference item, and at least one known first reference measurement associated with the first image,

b) accessing data related to one or more second images of one or more selection items, and at least one known second reference measurement associated with each of the second images,

c) processing the data associated with the first and second images, on the basis of the data associated with the respective associated reference measurements, to facilitate a visual comparison between at least one dimension of the reference item with at least one corresponding dimension of at least one of the selection items, and

d) enabling the user to visually compare the at least one dimension of the reference item with the at least one corresponding dimension of the at least one of the selection items, result of the comparison enabling the user to select an item out of the plurality of selection items.

According to a second aspect of the invention, there is provided an online shopping arrangement utilising the method for facilitating the selection of an item of the first aspect.

According to a third aspect of the invention, there is provided an electronic system for enabling a user to make an online selection of an item, out of a plurality of selection items of different sizes, the selection being based on a reference item located remotely from the plurality of selection items, the system comprising computational means arranged for;
receiving first data and second data, the first data being related to a first digital image of the reference item, and at least one known first reference measurement associated with the first digital image, the second data being related to one or more second digital images of one or more of the plurality of selection items, and at least one known second reference measurement associated with the respective one or more second digital image.
processing the received data in order to facilitate dimensional comparison of the reference item with at least one of the selection items;
facilitating a visual comparison of at least one dimension of the at least one of the selection items with a respective dimension of the reference item, and
receiving input from the user, indicative of the user's selection of a selection item, out of the plurality of items, based on the visual comparison.

Other aspects are also disclosed.

### BRIEF DESCRIPTION OF THE DRAWINGS

Some aspects of at least one embodiment of the present invention will now be described with reference to the drawings and appendices, in which:

FIG. 1 is a schematic flow diagram of an embodiment of the described method for facilitating online selection of an item.

FIG. 2 is a representation of a sample online log-on web page of the described system for facilitating online selection and purchase of items.

FIG. 3 is a representation of a sample main operational online web page of the described method and system for facilitating online selection and purchase of an item.

FIG. 4 is a representation of the operation of a drop-down menu associated with a specific item from FIG. 3 (in this particular case, the item is SHIRTS).

FIGS. 5A and 5B show embodiments of online web pages representative of operation of the described method and system for facilitating online selection and purchase of an item, directed to a user (FIG. 5A) and a retailer (FIG. 5B).

FIGS. 6A, 6B and 6C represent different stages of the manipulation of an A4 sheet of paper by a user on an operational page similar to the web pages shown in FIGS. 5A and 5B.

FIG. 7 is a representation of one step in an embodiment of the described method, in which the user overlays the correspondingly scaled reference item with a selected item in which the user is interested, to compare at least one dimension between the items.

FIGS. 8A and 8B are schematic flow diagrams of the process of interaction of an online user with a software implementation of an embodiment of the described method for facilitating online selection and purchasing, the user interaction being initiated from a centralised Fit2Buy™ dedicated website (FIG. 8A) or from a retailer homepage (FIG. 8B), respectively.

FIG. 9 is a schematic flow diagram of the process of online interaction of a retailer with a software implementation of an embodiment of the described method for facilitating online selection and purchasing.

FIGS. 10A and 10B form a schematic block diagram of a general purpose computer system upon which the method and the arrangements described can be practised.

### DETAILED DESCRIPTION

A method is described hereinafter that facilitates online selection of an item by a user. The item is typically selected out of a plurality of selection items of different sizes. The selection items are typically located remotely from the user.

The embodiments described hereinafter relate to online shopping arrangements. The method described effectively scales images of the items the buyers are interested in purchasing (throughout this specification also referred to as “selection items”), to the images of the buyers' own clothing items (throughout this specification also referred to as “reference items”), in order to determine if a particular selected item will fit. The reference items are located at a location that is convenient to the user, but is remote from the plurality of selection items.

Users upload data associated with their clothing sizes into the system by selecting reference items from their own wardrobe that best fit. The referenced items are placed on a bed, or the ground, or on any other flat surface. Next to the item, the user places a plain A4 sheet of white printer paper. A photograph is then taken using a camera, web cam, mobile phone or any other device able to either capture the image or convert it into a digital form capable of being loaded onto an electronic system associated with the proposed system and method. Thus an image is obtained of the reference item and of the A4 sheet, also referred to as a scaling object, having at least one known dimension. Each known dimension of the scaling object defines a reference measurement associated with the image of the reference item.

While even one long side of the A4 sheet of paper may be sufficient for the purpose of scaling the respective item, it is preferable that the photograph or image includes the entire clothing item and the entire A4 sheet of paper. If more than one type of clothing is of interest, the picture can be arranged to include all of the clothing items, together with the A4 sheet. Alternatively, each of the clothing items may be included in separate photographs. Again, each photograph preferably includes the entire image of the respective clothing item and the A4 sheet of paper. As far as uploading the digital images is concerned, there are generally two possibilities. In a first scenario, the images are kept on the user's computer, or any memory medium, including portable memory sticks, that a user can easily carry around. This option provides the user with improved privacy and access to the user's reference images, but is somewhat inconvenient in that the user generally does not have access to the images from other computer systems. Alternatively, the images may be uploaded to a server. In this case, the user can access the images from any computer system or other electronic device with Internet access. Once the images are uploaded to the server, a dedicated computer program scans the uploaded image and locates the sheet of A4 paper, either through the user indicating its position in the image, or automatically. The image is scaled to a pre-determined grid. The digital photo is then resealed and saved for future use.

A user may process and store an unlimited number of images. For example, one or more images may be processed for each type of clothing, such as shirt, shorts, pants, etc. A user may prefer to have at least one image for each sub-type of clothing, such as O-neck T-shirt, V-neck T-shirt, polo, long-sleeve shirt, etc. After the user chooses the type of item, the user is offered a selection of items of the same type, which can be purchased.

Participating retailers, or private users wishing to offer clothes for sale, similarly take photographs of the items offered for sale, which are uploaded in the system and made available to the dedicated computer program of the described arrangement. This will allow items of clothing to be compared, thus enabling the user to assess the suitability of the new item to the user's specific proportions. Again a scaling item in the form of an A4 sheet of paper is included in each digital photo. Each known dimension of the A4 sheet defines a respective reference measurement associated with the image of each respective retailed item (selection item). The presence of such a reference dimension enables the items to be suitably scaled and presented to the user on the screen together with the scaled images of the corresponding reference item/s.

Whether via a local hard disk drive, a memory stick, or via the hard disk drive of the dedicated server to which user has pre-uploaded respective images, once logged-on to the dedicated computer program, the user has access to the user's previously stored images of reference and selection items. The images are suitably scaled to facilitate easy comparison. The user's own item is shown as a translucent overlay, able to be moved by the user to any position within the boundaries of the screen and with respect to a respective selection item considered for purchasing, which is shown as a background image. This enables the user to manipulate the images in a convenient manner. For example, the user can place the translucent image of the reference clothing item over specific parts of the background image to determine the fit of the prospective item at specific points relating to the user's body. In this way, the user is able to assess if the width at the chest of a shirt is smaller or larger and to get a feel as to the difference between the size of the prospective shirt and a shirt of known fit. Thus the user is enabled to visually compare at least one dimension of the reference item with at least one corresponding dimension of the at least one of the selection items. As a result of the comparison, the user can select one or more items from the plurality of selection items.

Some special features are also implemented in the application program executing the disclosed method, which may affect the automatic selection of a “reference” background image when comparing certain clothing items. For example, if an attempt is made to compare a pair of jeans to a pair of shorts and the images of both items are scaled with respect to the size of the shorts, the size of the image containing the jeans would be significantly larger than that containing the shorts and the image will extend outside the viewing window. This effect may be desirable if, for example, a user wishes to compare in detail the shorts only with the upper section of the jeans. The enlarged image of the shorts in this case will facilitate such a comparison. If, however, the entire image of the jeans is required to be in the viewing window, the application program would initially locate, out of the two images comprising the jeans and the shorts, the image where the reference A4 sheet is of a smaller relative size. This sheet, which in the foregoing example is the A4 sheet associated with the jeans, is then used as a reference and the other image is scaled correspondingly. This procedure will ensure that the entire image of the jeans is fit in the viewing window. However, the image of the shorts in the viewing window will be substantially reduced in this case.

The margin of error is reduced as the scale is provided by an A4 sheet of paper and not the clothes themselves. Advantages of the A4 sheet of paper are that its size is standardised worldwide and that such sheets are easily accessible for both users and sellers.

Apart from being able to compare items of clothing, photograph or digital images of a user's face and head may also be uploaded into the system. The images may be scaled and provided to the user as reference images to facilitate selection and purchasing of sunglasses or other accessories. The user thus has the ability to superimpose various sunglasses onto an image of the user's own face and determine not only the fit, but also the style most appropriate to the user's taste and facial structure. Similar functionality may also be made available with respect to shoe purchases, where a user can verify not only the length, but also the width and other specific dimensions unique to the user's feet.

Another functionality of the system is that it enables users to use full body images by taking such photographs, using a webcam. For this purpose, the user stands in front of the webcam holding an A4 sheet of paper. A specialised computer software application takes a photograph, which is automatically re-scaled. The user then specifies the desired item of clothing they would like scaled, by pointing to the basic dimensions on a respective section of their body. The program finds, automatically or semi-automatically, the A4 sheet of paper and performs the scaling task. The user can then overlay the respective item over the image of his/her body and evaluate the suitability of the item in question.

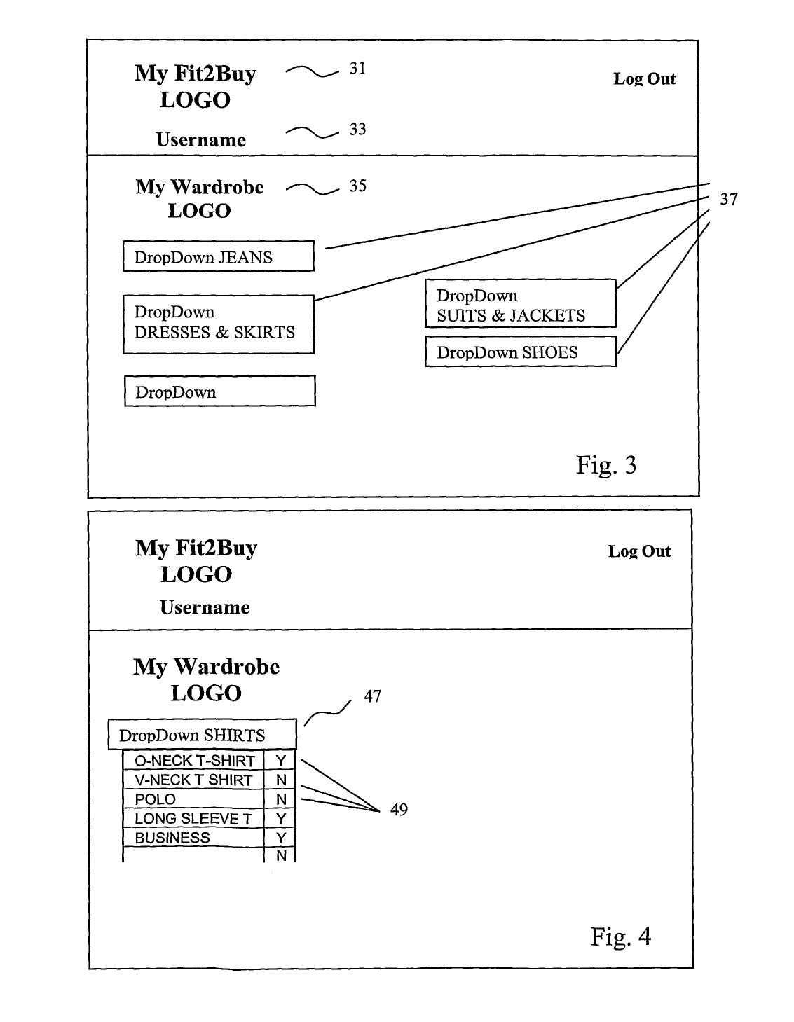

The detailed interaction of the user with the computer program is as follows. While shopping online at the site of a specific retailer, a user will find an item they may be interested in buying. On the page with the item description (price, etc.), there is a button or icon with the logo of the specific service (i.e. Fit2Buy™ or FitWell™). When the button is depressed, a popup window, such as the one shown in FIG. 2, appears requesting a user to enter their email address and/or other registration details. If already registered, the user is presented with the option to select one or more of the user's reference items of clothing, as shown in FIG. 3. The user is then offered sub-menus that enable the user to select a specific item of interest, as shown in FIG. 4. The item that the user has indicated interest in, is then displayed transparently or translucently superimposed over the respective reference item, or vice versa, as seen in FIG. 7. The user is able to move the superimposed image so as to line up the height, width, etc., thus facilitating an accurate comparison.

Besides this, there are options for the user to try a size larger, a size smaller, or to return to the retailer's webpage and purchase the item. This function can be automated by programming the system to automatically scale at least one dimension of a number of selection items the user may be interested in, and compare the scaled dimension to a corresponding dimension of the reference item provided. The user may then be presented with a limited number of one or more items, to which one or more dimensions of the reference item fit best. The criteria for how well an item “fits” may be based on the differences in a predetermined single dimension or on a standard deviation when several dimensions of each selection item are compared to respective dimensions of the reference item. However, it is preferred that the final choice of selection item is left to the user. The user can thus choose among selected items by superimposing the selection items over the reference item in the above described manner. An embodiment where one or more selection item images are each automatically and simultaneously overlayed over a corresponding image of the selection item, is also possible. Automatic overlay is performed on the basis of a predetermined number of key points on the reference item being made to match with corresponding points on the respective selection item.

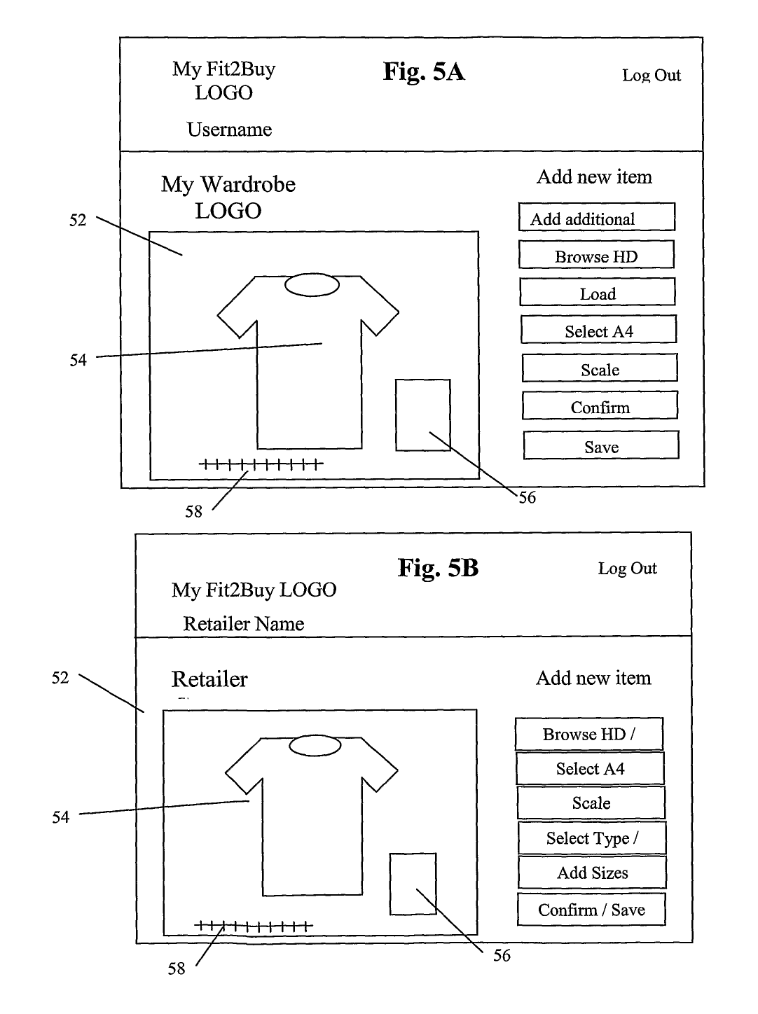

Should the user not be registered, once the user is taken to the site, the user is presented with a simple registration process, as shown in FIG. 2. If the user does not have a reference item of clothing, the user is enabled to upload images of one or more reference items, by way of a loading window (52, 62 and 72 in FIGS. 5A-B, 6A-6 and 7, respectively) or to obtain an automatic scan using a web camera, should a web camera be available on the computer system currently used by the user. A user does not have to have a reference image of an item that is identical to the item of interest. For example a collared t-shirt, v-neck t-shirt, round neck t-shirt, long sleeved t-shirt can all be compared to a single reference item (for example, a v-neck t-shirt), should the user not want to load all the individual items.

### EXAMPLE

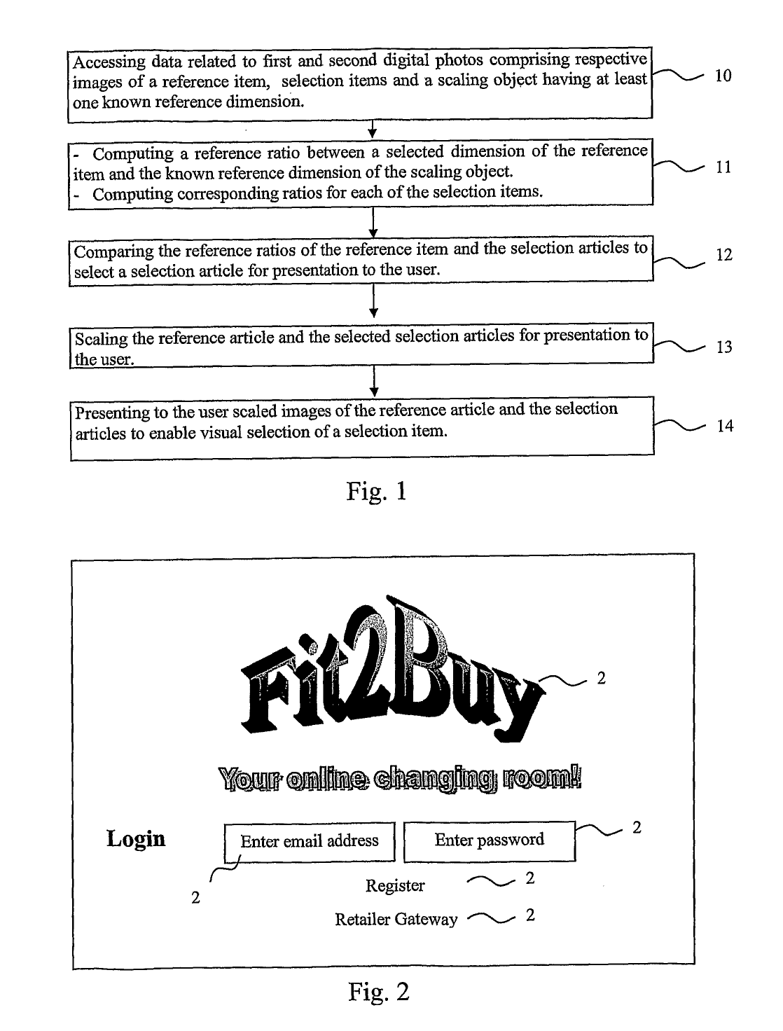

FIG. 1 shows a flow diagram of an embodiment of the method for enabling a user to select, out of a plurality of items retailed online, an item of suitable size. As described hereinbefore, the first step (10) comprises accessing data related to a first digital photograph that includes an image of the reference item, and data related to one or more second digital photos, each comprising an image of one or more selection items. Each of the first and the second digital photos also comprises an image of a scaling object located adjacently to the respective one or more items in the photo. At least one dimension of each scaling object is known, by way of the data associated with this dimension being provided in the photograph or with the photograph, or the object being of a well-known standard size. Examples of such objects can include an A4 sheet of paper, a CD or a DVD.

In step 11, a reference ratio between at least one dimension of the reference item and the known reference dimension of the scaling object is computed. Corresponding ratios are also computed for each of the selection items. The reference ratio for the reference item is then compared, in step 12, with the corresponding ratios computed for the selection articles, to select at least one selection article for presentation to the user. The selection process may be only partially based on the ratio comparison and other criteria may additionally be applied. For example, the user may have some requirements related to colour, style etc, which may affect the selection process. The computed ratios are also used, in step 13, to correspondingly scale the reference article and the selected at least one selection article for presentation to the user.

Finally, in step 14, the scaled images of the reference article and the at least one of the selection articles are presented on the screen of the user's computer system to enable the user to choose an item, out of the at least one selection item, by visually comparing the scaled image of the reference item with the scaled image of each of the at least one selection items. Of course a user may choose to send more than one reference items. In such an instance, each of the reference items is resealed and forwarded back to the user so that the user can visually compare the match of the selection items to each of the reference items.

FIGS. 2 to 7 show the appearances of web pages embodying the described online shopping arrangement.

FIG. 2, in particular, exemplifies an entry/gateway web page that introduces the user to the online shopping arrangement. As shown in the figure, the web page includes:
A logo 21 associated with the online shopping arrangement (in this case—the “Fit2Buy™” logo);
A registered user “enter email address” box 23;
A registered user “enter password” box 25;
A “register” link 27, for non-registered users; and
A “retailer gateway” link 29, which is an entry point for retailer users to a main web page of the arrangement, that is very similar to the webpage for private users. This link enables the associated retailers to access and alter their catalogues.

The first page that a user encounters, once logged onto the online shopping main website, is illustrated in FIG. 3. As shown in the figure, this introduction page comprises;
A logo 31 associated with the online shopping arrangement (“My Fit2Buy” logo);
Username box 33;
Shopping history link, not shown, that is available after the first shopping experience associated with the online shopping arrangement;
“My Wardrobe” logo 35, which tags a section of the webpage dedicated to various clothing items of the user;
dropdown boxes 37 with headings that include, but are not limited to the following:
   shirts
   pants/shorts
   jeans
   skirts/dresses
   shoes
   facial accessories
   suits/coats/jackets
   underwear/swimmers

FIG. 4 illustrates the appearance of the web page, where one of the drop-down boxes/menus is selected. As shown in the figure, such a selection results in sub-menus 49 being offered to the user, which comprise sub-categories of items. For simplicity, only a single drop down box 47 (Shirts) from the menus shown in FIG. 3, is represented in FIG. 4, while the remaining drop boxes have been omitted. The symbol next to an item, indicates if a reference item has been loaded on the system for the respective item. Selecting an item will bring up the respective reference item, if one is loaded (Y), or a load page, if no reference item is loaded (N).

The interface of the arrangement is similar for users and retailers. This is illustrated in FIGS. 5A and 5B, which show an example of pages associated with loading of a reference item on the database of the online shopping arrangement, by users (FIG. 5A) and loading of selection items by retailers (FIG. 5B). In this instance, the appearance of these pages is triggered by selecting the item “O-neck T-shirt” in the drop-down sub menu of FIG. 4. As discussed above, if an uploaded item exists, the web pages of FIGS. 5A and 5B can display that uploaded item on the user's screen. However, these web pages also facilitate saving of new reference and selection items, if none was previously loaded. The web pages of both of FIGS. 5A and 5B comprise the following components:
a logo (in this case—“My Fit2Buy™” logo);
Users name box;
Shopping history link (not shown);
“My Wardrobe” logo;
Load window 52, in which the loaded image of the reference is viewable and comparable with the images of respective selection items, or in which the loaded image of the selection items is viewable;
“Instructions” window (not shown) can also be included, which will list commands that will guide a user through the image uploading or image comparison routines. Instructions may include:
   open new window
   take a photo or image of the “clothing item”
   ensure all of the “item” and all of the A4 sheet of paper is in the image
   Example cartoon;
“Browse” button (browse through hard drive for image of reference item);
“webcam” button (not shown) that will allow a user to use webcam to take image of clothing item;
loaded image 54;
Select A4 sheet of paper 56;
Confirm size/selection (ensure all A4 sheet selected with no surroundings);
“scale” button that performs the scaling of the image;
“save button” that saves the reference item; and
“Replace with new item” button (not shown).

A ‘reference scaling ruler’ 58 is also included at the bottom of the operational window 56. The ruler is indicative of the correspondence between a unit length of the scaled images and a predetermined standard length or size. The ruler enables the users to work out any dimension or difference between two superimposed items in size or in units, such as cm, mm or inches. The scale of the ruler is determined using the A4 scaling sheet as a reference. The ruler may be especially useful when presented on a screen together with two overlaying items. The ruler will be moveable so that users can float it over the images of the clothes and determine with greater accuracy the difference in size of the items. This will indicate to a user that, for example, half an inch might be the average difference between small and medium, an inch between medium and large, etc.

Most of the above described buttons effectively represent stages in the process of loading an image and performing the scaling operation. For example; when adding an item, the user first selects the option to “add new item”, browses the hard disk drive, or respective online drives, for the image of the item, then selects an item from the hard disk drive and loads it onto the web page. The user then selects the A4 page. The user will be then prompted to confirm if the reference image has been properly scaled (this can be determined by observing if the reference measurement covers the whole page or if some sections have been left out). The system then scales the image, by calculating the ratio between the size of the A4 page and that of at least one respective dimension of the reference item. The reference item is then saved onto the system. The process will be similar for retailers (FIG. 5B) with the only difference being that a retailer is able to add colours and sizes for the uploaded items.

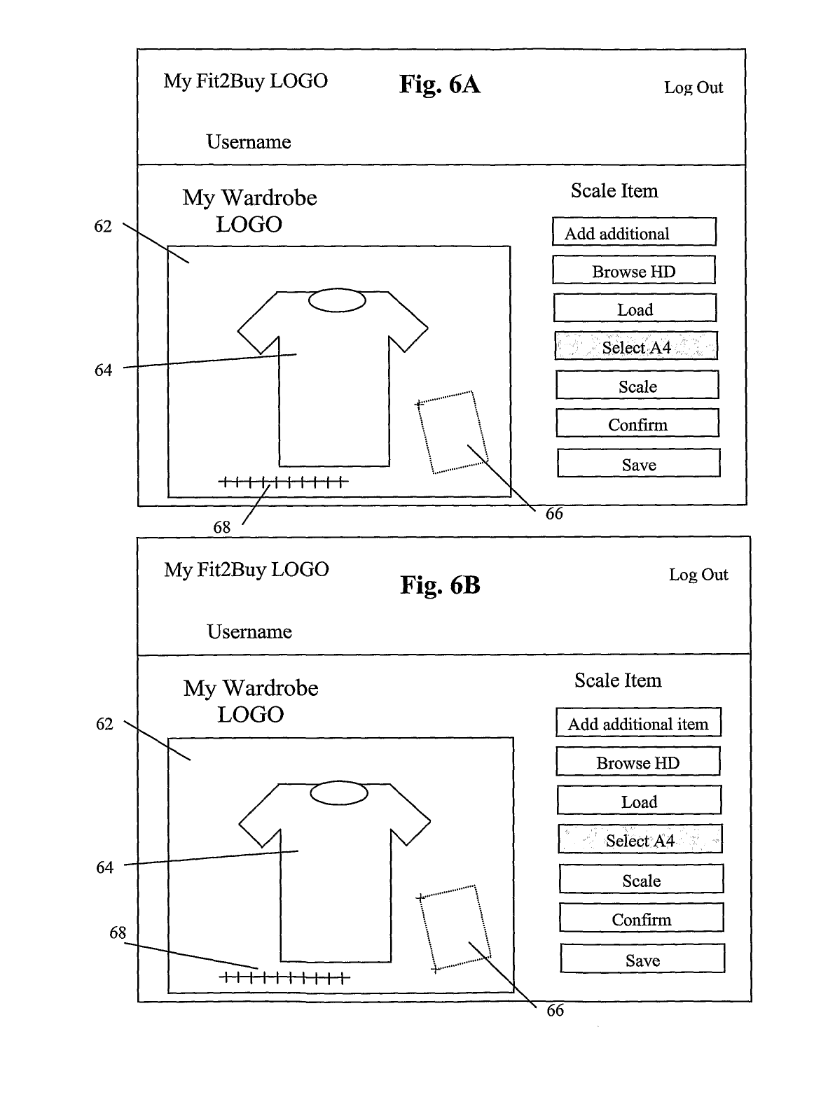

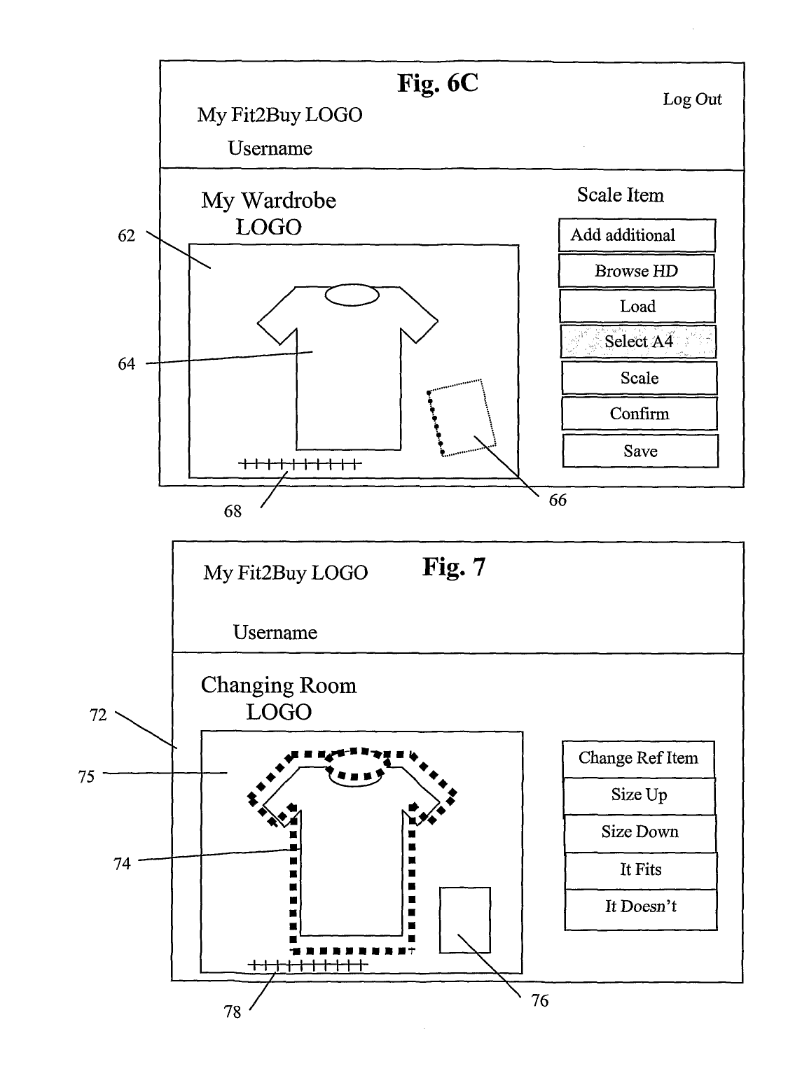

In more detail, the scaling process itself is illustrated in FIGS. 6A, 6B and 6C, which show different stages of the manipulation of an A4 sheet of paper by a user on an operational page similar to the web pages shown in FIGS. 5A and 5B. The user starts with marking a first corner (FIG. 6A) and a second corner along the length of the A4 sheet (FIG. 6B), thus indicating the exact scaling factor applicable when photographing the A4 sheet as a reference item. A line is then drawn manually or automatically to connect the two selected corners (FIG. 6C).

Further details of the above process are described in the following steps:
User loads the photo;
User selects the ‘Select A4’ button;
User is provided with a cursor (+) and instructions to select a corner of the A4 sheet (FIG. 6A)
User is prompted to select a second corner along one of the long sides of the A4 sheet (FIG. 6B)
A software application draws a line between the two corners selected by the user, effectively marking the long side of the A4 page (FIG. 6C);
User confirms the accuracy of the drawn line and, if the line is unsatisfactory, the user is given the option to repeat the exercise;
A software application measures the length of the line drawn on the screen and determines a scaling factor, based on the known length of the long side of the A4 page;
User saves the respective reference item;
User is given option to add another item or browse through site;

While the above description specifies a semi-manual fitting/scaling routine, the same functionalities can be performed by way of a dedicated software application which will automatically identify the A4 sheet on the provided digital photo, find the corners, fit a line along the long side of the sheet, compute the length of the side and calculate the applicable scaling factor.

Returning back to a shopping routine, in the final stage of the process, the user compares the reference item with one or more selection items, which are the subject of the user's interest. Based on the scaling factor, a software application can estimate one or more dimensions of the respective uploaded item. When a user with a specific uploaded reference item indicates interest in a particular selection item, all items of this type are presented to the user for selection. If the user indicates colour preference, the items which will be presented to the user may be selected on the basis of colour. In addition, at least one dimension of the available selection items may be compared to a corresponding dimension of the reference item, prior to the items being displayed to the user. Based on this comparison, only a few items, having the closest one or more dimensions to the reference item, may be presented to the user. The number of items presented on the screen to the user may be predetermined or selectable by the user.

FIG. 7 shows a screen representation of a case in which the image 75 of a single selection item is presented on the screen, where it is compared to an image 74 of a user's reference item. The internet webpage/site facilitating this functionality is figuratively named in this case “Changing Room”. The comparison is visual and is conducted by the user by superimposition of one of the items over the other. For the purpose of this superimposition, the selection item 75 is presented as a transparent or translucent image, which in FIG. 7 is indicated by way of a dotted line. The user may be given the option to select which item is translucent or transparent and which item is ‘on top’, during comparison. Also, the user may be given the option to select an outline of the clothing item, as opposed to using the image of the clothing item itself. This is achieved by removing the background and inverting the area removed. Since the background is usually a single colour, selecting and removing the colour will create a flat colour image with the area of the clothing item looking as if it had been cut out. That cut-out area will be the outline of the image. Removal of backgrounds allows for the creation of a wire frame or outline image of the clothes, which would be easier to scale and compare. Once the wireframe image is saved, colour could be applied to the wire frame line, as well as to the inside or outside of the image. The separation of the image from its background and the above-described ability to change the colours facilitates easier comparison between clothing items.

The following buttons are typically included in the web page of FIG. 7:
“My Fit2Buy™” logo;
Users name box;
Shopping history link (not shown);
“Fit2Buy™ Changing Room” logo;
comparison window 72;
“Transparency” button (not shown)—enables the user to change how transparent or translucent an image is, thus allowing the user to more accurately assess differences between the items. By default, the bottom image will be displayed with 0% transparency;
“Rotate” button (not shown)—provides the user with the ability to rotate both images 74 and 75 up to 360 degrees;
“Zoom” button (not shown)—the user will be able to zoom in on any part of the image to evaluate in greater detail the difference between the two images. The ‘reference scaling ruler’ 78 will change automatically with the zoom;
“Move” button (not shown) enables the user to select and move either image and to align both images as closely to one another as possible, to accurately assess the difference;
“Retailers Size Up/Down” dropdown menu enables the user to change the size of the item being considered from the retailers ‘library’ of loaded items;
“Accept” button (saves choice in history);
“It Fits/It Doesn't” button (not shown) saves automatically query results;
“Swap” button (not shown)—enables the user to alternate which image is ‘on top’, also allowing adjustment of the transparency or translucency of either image. In the preferred embodiment, only the “top” image will be translucent or transparent. However, either or both images can be made to appear so.
“Inverse colours” button (not shown) swaps the colour of the selected image to its exact opposite on the colour spectrum (black to white), or at least to a contrasting colour. An option to change the colour of an item to a particular colour, can also be provided to the user.
“Save and archive” button (not shown)—saves the record to create shopping history.

Further buttons and respective functionalities are also possible, such as:
“Change Ref Item” button, which enables the user to change the item from the user's ‘library’ of loaded reference items, which the user wishes to compare with the items considered for purchasing.

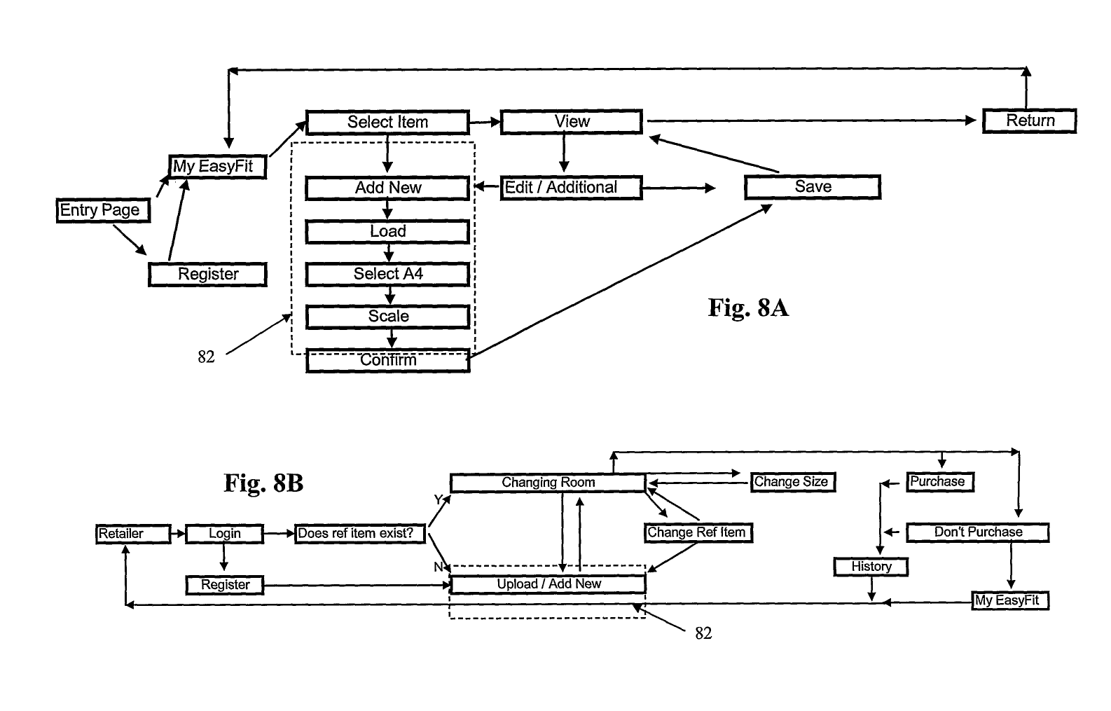

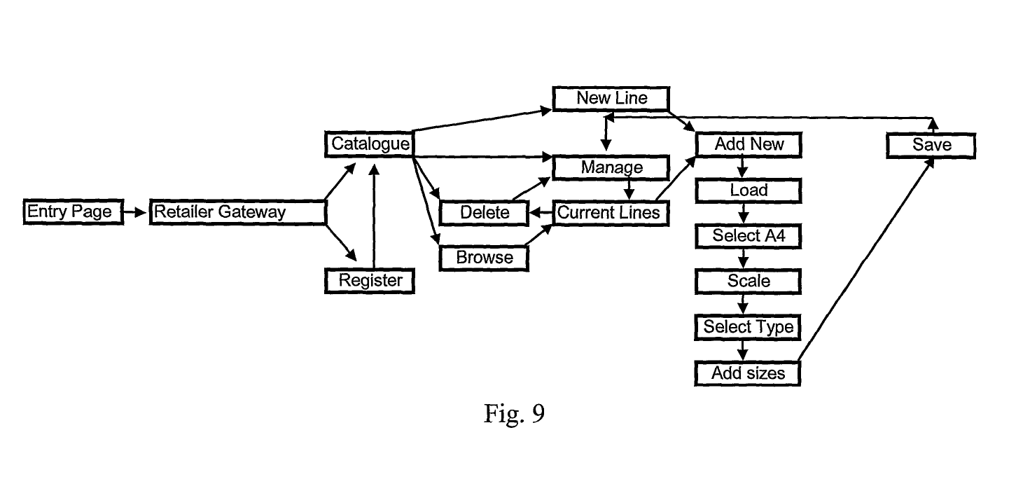

If the user accesses a retailer's webpage, looking for clothes, a link guides the user to the “Fit2Buy™” main webpage. For this purpose, retail items are accessed via a “View item” page at the retail site, which contains all retail information for the item, as well as a button for accessing the “Fit2Buy™” arrangement. The button will be recognisable by a quote or a slogan (such as “size me up!”) placed next to the button. Depressing the button will take the user to the Fit2Buy™ website, where the user will be able to log on to his/her profile. A cookie will carry the item's reference details. These functionalities will be further explained below with reference to FIGS. 8A, 8B and 9.

The flow chart in FIG. 8A represents a basic interaction process of uploading reference items for an individual user who logs-in directly to the Fit2Buy™ website of the described online shopping arrangement (FIG. 8A). As can be seen from FIG. 8A, an unregistered user is offered the opportunity to register. If the user is registered, the user is directed to the main interface page of the arrangement where the user can view and/or edit their loaded reference items, and add additional items. The flow diagram is self explanatory, since the processes involved have been described hereinbefore in relation to FIGS. 2 to 7. It should be noted that FIG. 8A describes the process of adding items only and does not include the further step of comparing items.

The flow chart in FIG. 8B represents the steps of a basic purchasing process for an individual user who logs-in to a retailer website. After registration, the user is directed to the user's “Changing Room”, where the user can access the user's reference images, saved on a dedicated server, on a user's computer or on portable memory media, and compare them with the images of items the user wishes to purchase. New reference images can also be uploaded. The step 82 of adding new images, marked as “Upload/AddNew” in FIG. 8B, is identical with the corresponding step 82 in FIG. 8A, which comprises the sub-steps included within the dotted rectangle.

The flow diagram of FIG. 9 shows the general process for retailers uploading new items onto the centralised Fit2Buy™ database. The process is similar to that of an individual user loading process with a few more options to allow for the addition of variations in size and catalogues of clothing. These options assist in managing the system on an ongoing basis with an ever increasing online library of items.

Users Database

Detailed records are maintained of participating users, including user demographics data, age, sex, search histories, purchase histories, location indicators, style preferences, sizes, purchasing habits, preferred sizes, style, items, brands etc. Detailed shopping profiles, based on such recorded data and/or the purchasing habits, style and personal preferences deduced from the recorded data, can be developed for each user. Retailers and market research companies will be able to purchase this information for a fee. The fee will depend is on the size of the research pool and the accuracy and details of the recorded information. Once knowledge of the online shopping arrangement has grown and a large number of online retailers have incorporated the system into their websites, the database including the data for all the shoppers will become a valuable asset and present an opportunity for providing additional income. As the database of users grows and the online shopping system website becomes more sophisticated, retailers can be offered premium packages which, for an increase in annual licensing fees, will allow the retailers to advertise on the site and reach users who will likely frequent their store. Also, based on the purchasing history of users, the system may develop a size- and style-profile of the user and may be arranged to directly suggest sizes and/or styles to the user, or provide information to each user related to the user's previous size and style choices. This service may be provided either automatically, or upon the user's request.

Search Facilities

With its potential, the described online shopping system is positioned to become the first point of reference for persons searching for apparel online. A dedicated search engine is used to search the database of apparel retailers. Such search facilities enable users to search for items and receive search results relating only to actual retail sites, thus eliminating the millions of obscure references to search terms, when using main stream search sites such as Google™ or Yahoo™!. This allows for the introduction of sponsored sites, paid for keywords and banner advertisements on the online shopping database. In this manner, third parties can be charged through a use of sponsor links associated with the website developed in relation to the online shopping arrangement. The development of the database will contribute Fit2Buy™ becoming an important hub in the global online retail industry with a large number of E-retailers.

Retailers' Database

In order to participate in the desired online shopping arrangement, a retailer has to pay a licensing fee. A database of participating retailers keeps track of data related to the sales of each retailer. Individual users can log onto one such retailer's site and view a list of all such sites. The database can be searched according to a number of variables. For example, searchers may wish to categorise the participating retailers depending on their number of sales, type or style of clothing, proximity to a particular location, etc. Monthly listings can be generated of all registered retailers that have sold at least a predetermined number of items within the online shopping arrangement. The listing can be made available to the users of the online shopping arrangement on each associated website or only on sites paying a predetermined fee. Also, the users may be informed, on each or only on selected associated websites, of any discounts currently available on any of the associated retailers. In time, as users develop purchasing patterns, the system will inform users when sales are on at their favourite sites (sites frequented by individuals). Retailers will be allowed to advertise on the site, which will generate an income through the use of sponsored links.

As the search facilities develop and advertising income increases, the licensing fee can be reduced and eventually removed, to make the retailer participation in the online shopping arrangement more profitable. The retailer data stored in the database may be associated with, and be searchable with respect to, at least one of the product sizes, any current promotions or prizes being given away, brands, quantities sold and retail turnover or each respective store. Participating retailer sites can also be classified on the basis of at least one of the number of their employees, type and/or volume of sold items etc.

Fashion and Style Guides

The rapidly evolving world of fashion makes it impossible for retailers to stay ahead of the fashion trends. The internet already acts as the best source for up-to-date information of the latest fashions. However even sites that focus on new looks often fall out of sync with what is selling fastest or what the newest look is. Thus, the majority of retailers are restricted to reviewing fashion trends and trying to stay in line with these trends. Data Tracking routines, built into the above described online shopping database, will follow traffic and provide the database administrators with the clearest indication of what is fashionable and which sites are ‘in’ at any point in time. Users are then presented with a map of the world, on which the geographic location of retailers receiving heavy traffic is highlighted in varying shades dependant on the volume of traffic (e.g. medium traffic can be colour-coded in yellow, heavy traffic—in red etc.). The software is able to differentiate between large retail stores and boutique sites, allowing customers to stay up-to-date with the latest global fashion trends and the latest underground or urban looks, as such develop.

Another feature of the online shopping arrangement is style-guide related software that presents to users an expert opinion of the latest and best looks from around the world. As traffic increases and the credibility of the online shopping system grows, writers will be hired to critique the latest looks and fashions. They will search through the database of retailers identifying unique, cutting edge looks and present them to users. The system's own database revealing the retail traffic of the participating retailers will also form a part of the trends and style evaluating process. All the search and advice facilities directed to the user will be integrated within the main website of the arrangement. Once a large number of customers start using the online shopping system, the shopping trends set by these customers will become representative of the global trends and the site will start attracting customers based on its user friendly arrangement and up-to date fashion advice.

Charity and Fund Rising

As the traffic through the online shopping website grows, the incorporation of charity-related functionalities will be established to provide clothing to people in need. Donations can be raised by asking for small amounts from each user, private or corporate, of the system. The collected money will be donated to particular charity organisations or funds. For example, visitors to the site can be given the option to contribute $0.10 or $0.20 cents to a particular foundation, this amount being billed to them as an additional charge when purchasing an item of clothing. Cooperation with credit card companies and online retailers will see this money used accordingly. Such fund-raising activities, on the other hand, will raise awareness amongst the public about the system and will heighten the profile of the company and the website.

Full Body Fit

Users can also upload a partial shot or a whole body shot of themselves into the system. An A4 sheet of paper may ether be held by the user or be otherwise included in the shot. In this way, the reference item uploaded by the user into the system comprises the image of either a portion of their body or their entire body. Again the reference measurement in this case is the form of a known dimension of the A4 sheet included in the digital photo (shot). The availability of images of the users' bodies will enable users to superimpose clothes they are considering purchasing onto the image of any part of their body. The feature allows people to mix and match items from different stores over the internet. The feature will work in collaboration with other development features such as the style guide. Looks can be suggested to users. Users have the opportunity to match items the users are considering buying, such as glasses and hats, trousers and jumpers etc. Apart from matching a single item, an image of the user's body will enable a plurality of items to be simultaneously fit to various portions of the user's body to match the items to each other and/or to the body.

Recommending Retailers to Users

As mentioned hereinbefore, tracking software will record details of each individual purchase and enquiry, eventually establishing a purchase pattern for each user. This information will be analysed and compared to other users with similar purchasing patterns. As a result, users will be provided with links to other retailers, whose style or cut of clothing is similar to a user's reference items. For example, the cut for Sass and Bide jeans may be similar to an emerging urban design from Spain, or a specific cut with Armani, etc. A dedicated computer program records the purchases of people and matches their preferences. Thus, other shoppers, who fit into Sass and Bide jeans, can find out which other jeans companies provide similar cuts. As the community of users and retailers grows, individual users will be able to build a virtual shopping mall of the retailers that best suit their style and more importantly produce apparel that best match the shape of their body.

Virtual Shopping Mall

As users develop preferences for where they like to shop, the tracking software will enable a virtual shopping mall to be defined or designed for each individual user, containing the sites of retailers frequented by the respective user. One advantageous feature of the mall is that it gives the user an option to confine his searches and/or shopping only to the retailers included in the virtual shopping mall. At the same time, the virtual shopping mall will work in collaboration with the other software programs associated with the online shopping system, to allow users to constantly expand the size of their shopping mall and to venture to sites of retailers that match their personal style. Users are able to add additional sites to their shopping mall in a similar way to ‘favourite’ sites on web browsers. The is added sites may include travel sites, DVD and entertainment stores, mobile phone stores, music stores, computer games stores etc. Unlike real shopping malls, in the virtual malls there will only be one company representing each industry space (e.g., music retail space can be offered to Apple). The space will go to the highest bidder. Alternatively, a user's input may also be requested when allocating the spaces. A company which has won a bid and is included in the shopping mall will be able to advertise to users at no charge, offer specials and promotions, etc. Advertising space within the users' virtual shopping malls can also be sold to a non-retailer third party.

A user can also be provided with suggestions of additional sites that the user can add to the user's virtual shopping mall. Such a recommendation for adding a site can be based on the volume of items retailed by the site and the relevance of at least one of these items to the user's purchasing history.

One arrangement can also include companies either being automatically included, or being suggested to the user for inclusion in the virtual shopping mall, for the duration of “specials” and/or other promotional events offered by the company.

Advertising space within the virtual malls can also be sold via competitions, prize draws etc., being constantly on offer. As all the user traffic runs through the main web page of the online shopping system, advertising is easily controlled and is presented to users at a minimum, in order to maximise user enjoyment. Due to the detailed database information on each user, advertisers can target users based on any number of criteria, and market directly to them in a manner similar to having a stand in a shopping mall.

The aim is for users to have sites similar to ‘Facebook™’ pages that are full of the sites and stores they frequent on the internet. Each site will have suggestions provided by other users to sites with similar styles or similar clothing fits. As this develops entire communities will appear, based on the convenience appeal of the online apparel and footwear retail system. The virtual shopping malls may also offer entertainment content including prize draws, competitions and/or other promotional events, in order to maintain the user's interest in the site.

Manufacturing Services/T-Shirt Factory

Within this technology, the software is also able to calculate measurements based a user's reference items. The accuracy is such that, instead of picking from sizes on offer, users can have items of clothing custom made, specific to their body dimensions. This service will initially be offered to small boutique sites that do not have excessively large orders to fill. Small sites that offer custom t-shirts, for example, will be initially approached and offered access to the manufacturing services. Users will select a print, while the user's dimensions, obtained from comparison with reference articles (as discussed hereinbefore) or from user's purchasing history, are instantly sent to the manufacturing facility, which will create the item of clothing. The user's details may be printed on the inside of the shirt instead of on a tag. The advantage for retailers is that shirts will only need to be created as they are sold, thus avoiding, the possibly of over-ordering or having to sell stock at reduced prices, to sell off the end of a line. Retailers will also benefit from not having to keep stock on hand, thus reducing handling, ordering and postage. As there is no stock to store, retailers will also be able to carry much larger ranges and will be able to offer much more variety to their customers.

The foregoing feature will also allow users to be offered the opportunity to have desired clothing items, created to the specific dimensions of their body, at a very low cost. For example, there is a large market for T-shirts associated with sporting team or rock band memorabilia. Advantages of the above-described online shopping system lie in convenience, low cost and large volume.

It is clear from the foregoing description that the new method and system for choosing an item, out of a plurality of items of different sizes, facilitates a convenient online selection and purchasing of clothing items.

The foregoing text describes only some embodiments of the present invention, and modifications and/or changes can be made thereto without departing from the scope and spirit of the invention, the embodiments being illustrative and not restrictive. For example, the above text has described the scaling functionality of the proposed system with regard to using the length of the standard A4 size sheet of paper. However, this does not have to be the case and other items of standard length can also be used, such as hangers, CDs, DVDs, rulers etc. In addition, the above described method relates to a user sending his reference images on one or more digital photographs. However, it is envisaged that standard non-digital photographs may also be used for the purpose of the method. In this instance, a scanner may be employed to transfer the image from the non-digital photograph into a digital form.

Also, only a single selection item was described as being superimposed over a reference item. However, it is envisaged that a reference item may be superimposed over more than one selection items simultaneously, thus visualising and facilitating a dimensional comparison between the reference item and the respective ones of the a plurality of selection items displayed on the screen. The simultaneous overlaying of the reference item with more than one selection items also allows the user to evaluate which of the displayed selection items best fits the reference item.

In addition, it is envisaged that instead of comparing the selection items on the basis of a known dimension of a scaling object that is also presented in the respective photos, the comparison can be effected on the basis of a known distance between the digital camera and the respective items at the time of taking each of the digital photos. The information of this distance can be provided together with each photo. Knowing this distance for each image can enable appropriate scaling and effective comparison of one or more dimensions of the reference item with these of the selection items, on the basis that the items have been photographed from the same distance.

Also, the reference measurement associated either with the reference item or with any of the selection items may be provided by the user or the retailer by way of direct measurement of a particular dimension of the article. For example a user wishing to purchase a shirt may include a digital photo of an old shirt of good fit. The photograph can be accompanied by data indicating that the sleeves of the shirt are of a particular length, which the user has measured himself. In this instance, the data related to the length of the sleeves represents the reference measurement associated with the reference item.

It also has to be noted that, even though the arrangement for choosing an item, out of a selection of items with different sizes, has been described with regard to online shopping for clothing, it is envisaged that the arrangement is applicable to the retail and purchasing of any goods, where the exact fit may be an issue. For example, it is envisaged that this retail arrangement will also be suitable for use with sporting items such as tennis rackets, golf clubs etc. Non-retail applications are also envisaged. For example, many promotional activities involve giving away T-shirts. The shirts are usually of a standard L-size and do not fit many of the targeted participants. The described arrangement enables promoters to give away vouchers, instead. Having the specified voucher number, a participant can then go online and, using the above described method, receive a shirt of exact fit.

Finally, the above photo-enabled online shopping arrangement has been described with reference to a computer network, wherein most of the respective functionalities are facilitated by a dedicated server, having access to data associated with digital photos uploaded by users and retailers. It is anticipated that users will generally access the system using a personal computer and an Internet connection. It should be mentioned, however, that the disclosed arrangement is not limited to personal computers and the online functionalities may be facilitated and accessed by other electronic systems, such as mobile phones.

### Hardware Implementation

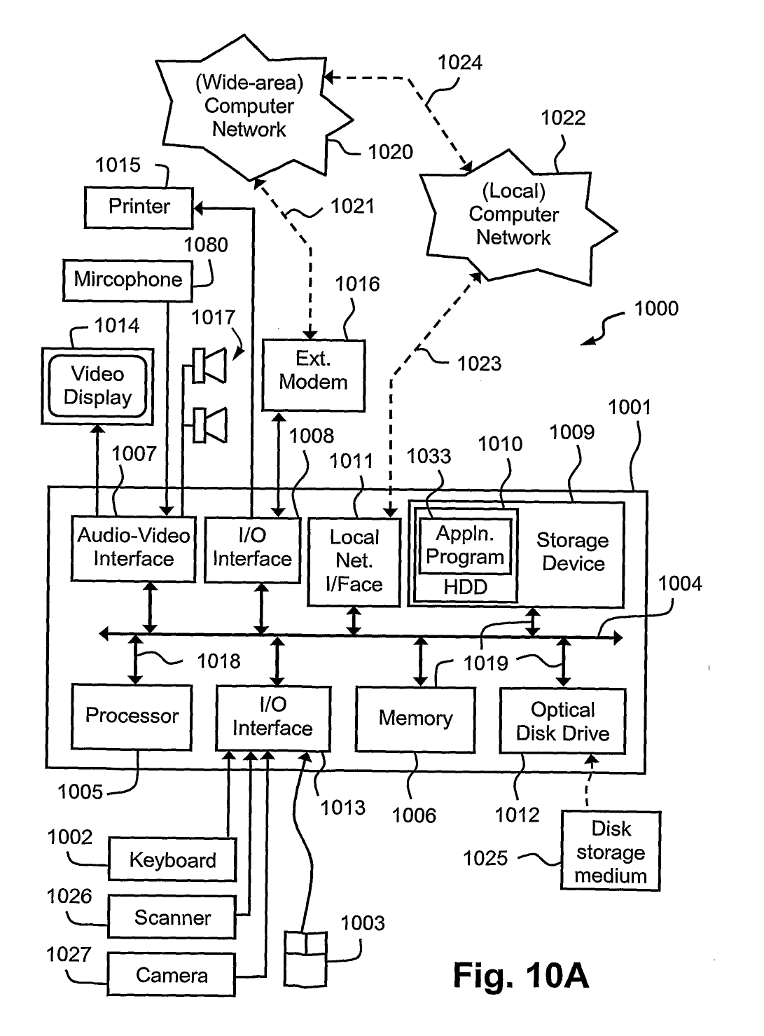

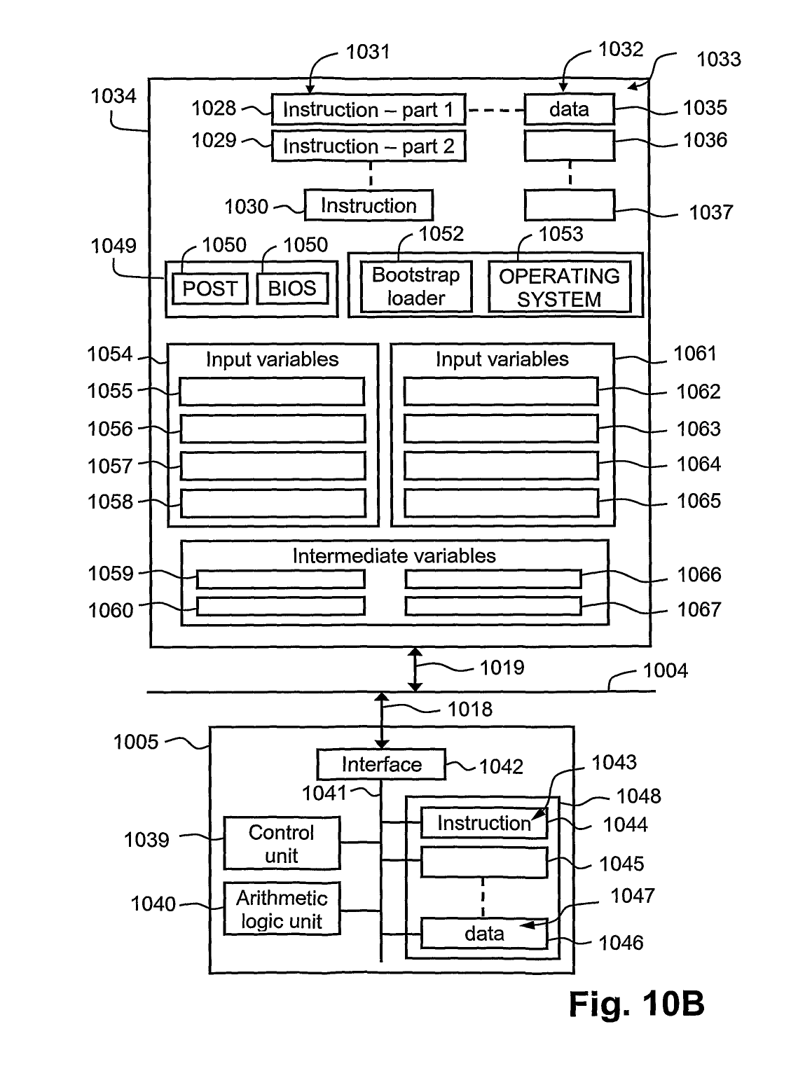

FIGS. 10A and 10B collectively form a schematic block diagram of a general purpose computer system 1000, upon which the various arrangements of the described method can be practiced.

As seen in FIG. 10A, the computer system 1000 is formed by a computer module 1001, input devices such as a keyboard 1002, a mouse pointer device 1003, a scanner 1026, a camera 1027, and a microphone 1080, and output devices including a printer 1015, a display device 1014 and loudspeakers 1017. An external Modulator-Demodulator (Modem) transceiver device 1016 may be used by the computer module 1001 for communicating to and from a communications network 1020 via a connection 1021. The network 1020 may be a wide-area network (WAN), such as the Internet or a private WAN. Where the connection 1021 is a telephone line, the modem 1016 may be a traditional “dial-up” modem. Alternatively, where the connection 1021 is a high capacity (eg: cable) connection, the modem 1016 may be a broadband modem. A wireless modem may also be used for wireless connection to the network 1020.

The computer module 1001 typically includes at least one processor unit 1005, and a memory unit 1006, for example formed from semiconductor random access memory (RAM) and semiconductor read only memory (ROM). The module 1001 also includes an number of input/output (I/O) interfaces including an audio-video interface 1007 that couples to the video display 1014, loudspeakers 1017 and microphone 1080, an I/O interface 1013 for the keyboard 1002, mouse 1003, scanner 1026, camera 1027 and optionally a joystick (not illustrated), and an interface 1008 for the external modem 1016 and printer 1015. In some implementations, the modem 1016 may be incorporated within the computer module 1001, for example within the interface 1008. The computer module 1001 also has a local network interface 1011 which, via a connection 1023, permits coupling of the computer system 1000 to a local computer network 1022, known as a Local Area Network (LAN). As also illustrated, the local network 1022 may also couple to the wide network 1020 via a connection 1024, which would typically include a so-called “firewall” device or device of similar functionality. The interface 1011 may be formed by an Ethernet™ circuit card, a Bluetooth™ wireless arrangement or an IEEE 802.11 wireless arrangement.

The interfaces 1008 and 1013 may afford either or both of serial and parallel connectivity, the former typically being implemented according to the Universal Serial Bus (USB) standards and having corresponding USB connectors (not illustrated). Storage devices 1009 are provided and typically include a hard disk drive (HDD) 1010. Other storage devices such as a floppy disk drive and a magnetic tape drive (not illustrated) may also be used. An optical disk drive 1012 is typically provided to act as a non-volatile source of data. Portable memory devices, such optical disks (eg: CD-ROM, DVD), USB-RAM, and floppy disks for example may then be used as appropriate sources of data to the system 1000.

The components 1005 to 1013 of the computer module 1001 typically communicate via an interconnected bus 1004 and in a manner which results in a conventional mode of operation of the computer system 1000 known to those in the relevant art. Examples of computers on which the described arrangements can be practised include IBM-PC's and is compatibles, Sun Sparcstations, Apple Mac™ or alike computer systems evolved therefrom.

The described method for online selection of items and online shopping arrangement may be implemented using the computer system 1000 wherein the processes of FIGS. 1, 8A, 8B and 9, as well as the interactive pages shown in FIGS. 2 to 7, may be implemented as one or more software application programs 1033 executable within the computer system 1000. In particular, the steps of the method for online selection of items and online shopping are effected by instructions 1031 in the software 1033 that are carried out within the computer system 1000. The software instructions 1031 may be formed as one or more code modules, each for performing one or more particular tasks. The software may also be divided into two separate parts, in which a first part and the corresponding code modules performs the image and the data processing and a second part and the corresponding code modules manage a user interface between the first part and the user.

The software 1033 is generally loaded into the computer system 1000 from a computer readable medium, and is then typically stored in the HDD 1010, as illustrated in FIG. 10A, or the memory 1006, after which the software 1033 can be executed by the computer system 1000. In some instances, the application programs 1033 may be supplied to the user encoded on one or more CD-ROM 1025 and read via the corresponding drive 1012 prior to storage in the memory 1010 or 1006. Alternatively the software 1033 may be read by the computer system 1000 from the networks 1020 or 1022 or loaded into the computer system 1000 from other computer readable media. Computer readable storage media refers to any storage medium that participates in providing instructions and/or data to the computer system 1000 for execution and/or processing. Examples of such storage media include floppy disks, magnetic tape, CD-ROM, a hard disk drive, a ROM or integrated circuit, USB memory, a magneto-optical disk, or a computer readable card such as a PCMCIA card and the like, whether or not such devices are internal or external of the computer module 1001. Examples of computer readable transmission media that may also participate in the provision of software, application programs, instructions and/or data to the computer module 1001 include radio or infra-red transmission channels as well as a network connection to another computer or networked device, and the Internet or Intranets including e-mail transmissions and information recorded on Websites and the like.

The second part of the application programs 1033 and the corresponding code modules mentioned above may be executed to implement one or more graphical user interfaces (GUIs) to be rendered or otherwise represented upon the display 1014. Through manipulation of typically the keyboard 1002 and the mouse 1003, a user of the computer system 1000 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1017 and user voice commands input via the microphone 1080.

FIG. 10B is a detailed schematic block diagram of the processor 1005 and a “memory” 1034. The memory 1034 represents a logical aggregation of all the memory devices (including the HDD 1010 and semiconductor memory 1006) that can be accessed by the computer module 1001 in FIG. 10A.

When the computer module 1001 is initially powered up, a power-on self-test (POST) program 1050 executes. The POST program 1050 is typically stored in a ROM 1049 of the semiconductor memory 1006. A program permanently stored in a hardware device such as the ROM 1049 is sometimes referred to as firmware. The POST program 1050 examines hardware within the computer module 1001 to ensure proper functioning, and typically checks the processor 1005, the memory (1009, 1006), and a basic input-output systems software (BIOS) module 1051, also typically stored in the ROM 1049, for correct operation. Once the POST program 1050 has run successfully, the BIOS 1051 activates the hard disk drive 1010. Activation of the hard disk drive 1010 causes a bootstrap loader program 1052 that is resident on the hard disk drive 1010 to execute via the processor 1005. This loads an operating system 1053 into the RAM memory 1006 upon which the operating system 1053 commences operation. The operating system 1053 is a system level application, executable by the processor 1005, to fulfil various high level functions, including processor management, memory management, device management, storage management, software application interface, and generic user interface.

The operating system 1053 manages the memory (1009, 1006) in order to ensure that each process or application running on the computer module 1001 has sufficient memory in which to execute without colliding with memory allocated to another process. Furthermore, the different types of memory available in the system 1000 must be used properly so that each process can run effectively. Accordingly, the aggregated memory 1034 is not intended to illustrate how particular segments of memory are allocated (unless otherwise stated), but rather to provide a general view of the memory accessible by the computer system 1000 and how such is used.

The processor 1005 includes a number of functional modules including a control unit 1039, an arithmetic logic unit (ALU) 1040, and a local or internal memory 1048, sometimes called a cache memory. The cache memory 1048 typically includes a number of storage registers 1044-1046 in a register section. One or more internal buses 1041 functionally interconnect these functional modules. The processor 1005 typically also has one or more interfaces 1042 for communicating with external devices via the system bus 1004, using a connection 1018.

The application program 1033 includes a sequence of instructions 1031 that may include conditional branch and loop instructions. The program 1033 may also include data 1032 which is used in execution of the program 1033. The instructions 1031 and the data 1032 are stored in memory locations 1028-1030 and 1035-1037 respectively. Depending upon the relative size of the instructions 1031 and the memory locations 1028-1030, a particular instruction may be stored in a single memory location as depicted by the instruction shown in the memory location 1030. Alternately, an instruction may be segmented into a number of parts each of which is stored in a separate memory location, as depicted by the instruction segments shown in the memory locations 1028-1029.

In general, the processor 1005 is given a set of instructions which are executed therein. The processor 1005 then waits for a subsequent input, to which it reacts to by executing another set of instructions. Each input may be provided from one or more of a number of sources, including data generated by one or more of the input devices 1002, 1003, data received from an external source across one of the networks 1020, 1022, data retrieved from one of the storage devices 1006, 1009 or data retrieved from a storage medium 1025 inserted into the corresponding reader 1012. The execution of a set of the instructions may in some cases result in output of data. Execution may also involve storing data or variables to the memory 1034.

The disclosed image and data processing arrangements use input variables 1054 that are stored in the memory 1034 in corresponding memory locations 1055-1058. After the processing of the data and/or images forwarded by a user, output variables 1061 are generated that are stored in the memory 1034 in corresponding memory locations 1062-1065. Intermediate variables may be stored in memory locations 1059, 1060, 1066 and 1067.

The register section 1044-1046, the arithmetic logic unit (ALU) 1040, and the control unit 1039 of the processor 1005 work together to perform sequences of micro-operations needed to perform “fetch, decode, and execute” cycles for every instruction in the instruction set making up the program 1033. Each fetch, decode, and execute cycle comprises:
(a) a fetch operation, which fetches or reads an instruction 1031 from a memory location 1028;
(b) a decode operation in which the control unit 1039 determines which instruction has been fetched; and
(c) an execute operation in which the control unit 1039 and/or the ALU 1040 execute the instruction.

Thereafter, a further fetch, decode, and execute cycle for the next instruction may be executed. Similarly, a store cycle may be performed by which the control unit 1039 stores or writes a value to a memory location 1032.

Each step or sub-process in the processes of FIGS. 1, 8A, 8B and 9 is associated with one or more segments of the program 1033, and is performed by the register section 1044-1047, the ALU 1040, and the control unit 1039 in the processor 1005 working together to perform the fetch, decode, and execute cycles for every instruction in the instruction set for the noted segments of the program 1033.

In view of the above described computer system, the method for online selection of items may be provided in the context of a centralised Fit2Buy™ server 1000 accessible by users by way of LAN 1022 or WAN 1020. Users may use their personal computers to send digital photos comprising the reference images. The images, as well as any separately provided reference measurement data, are uploaded to the dedicated online server computer system 1000, which is programmed to process the image data and the reference data and enable the user to download from the system appropriately re-scaled images that are displayed on the user's monitor. Based on the displayed downloaded images, the user may select one or more selection items. The user's choice is then uploaded back to the dedicated Fit2Buy™ server computer system 1000 where it is processed and the dispatch of the requested item/s arranged.

Thus, an electronic system for enabling a user to make an online selection of an item, out of a plurality of selection items of different sizes, is also included within the scope of the invention.

In one embodiment, the system 1000 comprises computational means, in the form of a processor 1005, arranged for receiving first data and second data. The first data is related to the first digital image of the reference item and at least one known first reference measurement associated with the first digital image. As discussed in the previous text, the first digital image is usually a photograph of a selected article of clothing of known good fit. The known first reference measurement can be a known dimension of a suitable scaling item, such as an A4 sheet. The scaling item is also included in the photograph adjacent the reference item. The second data is related to one or more second digital images of one or more of the plurality of selection items and at least one known second reference measurement associated with the respective one or more second digital image. The at least one known second reference measurement can also be the known dimension of an A4 sheet or any other item of standard length.

The processor 1005 processes the received data in order to enable scaling of the reference and/or selection items. This processing facilitates dimensional comparison of the reference item with at least one of the selection items. A visual comparison is then facilitated by the processor 1005, on the display of the user's personal computer, between at least one dimension of the at least one of the selection items with a respective dimension of the reference item. Finally, the processor 1005 of the electronic system is arranged to receive an input by the user, indicative of the user's selection of a selection item, out of the plurality of items, based on the visual comparison.

The server system 1000 can be further arranged for alternative functionalities. For instance, the processor 1005 may compute a reference ratio between a selected dimension of the reference item and the known reference dimension of the first scaling object of the same digital photograph. This ratio may then be used by the processor 1005 to compare the reference ratio with corresponding ratios computed for at least one of the selection items. The processor 1005 can then use this computation to select at least one selection item, for which the ratio between the item's respective dimension and the known reference dimension of the scaling object is the closest to the reference ratio. The processor then transmits data of the selected at least of one selection item to the user display means.

Thus, as a result of processing the digital images, the processor 1005 can send to a user computer system data that enables the generation, on the screen of the user computer system, of a scaled image of the reference item. The user is enabled to manipulate the scaled image by overlaying the image with a correspondingly scaled image of at least one of the selected at least one selection items, the superimposed images facilitating a dimensional comparison between the reference item and the respective selection items.

It has to be noted that, instead on relying on users utilising their personal computers, the method of online selection of items may alternatively be implemented in dedicated hardware systems (kiosks) located in retail centres. The hardware implementation of such dedicated kiosks may include one or more integrated circuits performing the functions or sub functions described above. Such dedicated hardware may include graphic processors, digital signal processors, or one or more microprocessors and associated memories. Alternatively, users may be able to access and utilise the described online arrangement using their mobile phones.

It is apparent from the above description that the method and system for choosing an item, out of a plurality of items of different sizes, facilitates a convenient online selection and purchasing of clothing items. Accordingly, the described system and method are directly applicable to the retail industry.

1. A method for facilitating online selection of an item by a user, the item being selected out of a plurality of selection items of different sizes, the selection being based on a reference item located remotely from the plurality of selection items, the method being performed on an electronic system and comprising the steps of;
a) accessing data related to a first image of the reference item, and at least one known first reference measurement associated with the first image,
b) accessing data related to one or more second images of one or more selection items, and at least one known second reference measurement associated with each of the second images,
c) processing the data associated with the first and second images, on the basis of the data associated with the respective associated reference measurements, to facilitate a visual comparison between at least one dimension of the reference item with at least one corresponding dimension of at least one of the selection items, and
d) enabling the user to visually compare the at least one dimension of the reference item with the at least one corresponding dimension of the at least one of the selection items, the result of the comparison enabling the user to select an item out of the plurality of selection items.

2. The method of claim 1, wherein;
each of the first and the second images is a digital image obtained from a corresponding digital photograph;
each digital photograph, including a corresponding first or a second digital image, also comprises an image of a scaling object located adjacent the respective first or a second digital image, and having at least one known reference dimension defining the respective reference measurement;
step c) comprises the steps of;
computing a reference ratio between a selected dimension of the reference item and the known reference dimension of the scaling object, and comparing the reference ratio with corresponding ratios computed for one or more of the selection items; and
selecting at least one selection item to be offered to the user for comparison with the reference item, the selection being based, at least partially, on the ratio comparison; and
step d) comprises enabling the user to choose an item, out of the at least one selection items selected in step b) by visually comparing the reference item with each of the at least one selection items.

3. The method of claim 1, wherein;
each of the first and the second images is a digital image obtained from corresponding digital photographs;
the at least one reference measurement, associated with the images of the reference item and each of the plurality of selection items, comprises the distance between the camera and the respective item at the time of taking the digital photograph;
step c) comprises;
comparing the reference item with each of the selection items on the basis of ratios between at least one item dimension, the dimension being effectively estimated on the basis of the corresponding first and second images, when the digital photographs of each of the respective selection and reference items are taken from substantially identical distances; and
selecting at least one selection item to be offered to the user for comparison with the reference item, the selection being based, at least partially, on the ratio comparison; and
step d) comprises enabling the user to choose an item, out of the at least one selection item selected in step c) by visually comparing the reference item with each of the at least one selection item.

4. The method of claim 1, wherein in step d), the data related to one or more first and second images is used to generate, on the screen of a user electronic system, scaled images of the reference item and the at least one selection item, the user being able to manipulate the scaled images by overlaying the reference image with any of the correspondingly scaled images of one or more of the at least one selection item, the superimposed images enabling the user to make a dimensional comparison between the reference item and the respective selection item.

5. The method of claim 1, wherein the user is enabled to superimpose the scaled image of the reference item with all of the scaled at least one of the selection images simultaneously.

6-12. (canceled)

13. The method of claim 1, wherein the reference item is of a substantially the same type as the selection items.

14-15. (canceled)

16. The method of claim 1, wherein the image of the reference item comprises at least a portion of the user's body, the portion being related to a use of the selection items.

17. An online shopping arrangement utilising the method for facilitating the selection of an item of claim 1.

18. The online shopping arrangement of claim 17, wherein the arrangement comprises a dedicated website that is accessible directly, or via websites of participating retailers.

19-40. (canceled)

41. The online shopping arrangement of claim 17, wherein, upon purchasing an item, a user is provided with dimensional data corresponding to the purchased item.

42. The online shopping arrangement of claim 17, wherein the selection items and the reference item are clothing items.

43-46. (canceled)

47. An electronic system for enabling a user to make an online selection of an item, out of a plurality of selection items of different sizes, the selection being based on a reference item located remotely from the plurality of selection items, the system comprising computational means arranged for;
receiving first data and second data, the first data being related to a first digital image of the reference item, and at least one known first reference measurement associated with the first digital image, the second data being related to one or more second digital images of one or more of the plurality of selection items, and at least one known second reference measurement associated with the respective one or more second digital image.
processing the received data in order to facilitate dimensional comparison of the reference item with at least one of the selection items;
facilitating a visual comparison of at least one dimension of the at least one of the selection items with a respective dimension of the reference item, and
receiving input from the user, indicative of the user's selection of a selection item, out of the plurality of items, based on the visual comparison.

48. The electronic system of claim 47 wherein the first and the second digital images are included in respective digital photographs, apart from the image of the respective one or more selection or reference items, each of the digital photographs comprising an image of a scaling object located adjacent the respective one or more reference or selection items and having at least one known reference dimension defining the known measurement, wherein the computational means of the electronic system is further arranged for;
computing a reference ratio between a selected dimension of the reference item and the known reference dimension of the first scaling object of the same photograph, and comparing the reference ratio with corresponding ratios computed for at least one of the selection items;
selecting at least one selection item, for which the ratio between the item's respective dimension and the known reference dimension of the scaling object is the closest to the reference ratio; and
transmitting to user display means data of the selected at least of one selection item.

49. The electronic system of claim 47, wherein the computational means processes the digital images and sends to a user computer system data that enables the generation, on the screen of a user computer system, of a scaled image of the reference item, the user being able to manipulate the scaled image by overlaying the image with a correspondingly scaled image of at least one of the selected at least one selection items, the superimposed images facilitating a dimensional comparison between the reference item and the respective selection items.

50. A computer-implemented method for facilitating online purchase of an item by a user, said method comprising the steps of:
retrieving a first digital image of an item selected by said user, said first digital image comprising a first scaling object;
obtaining a second digital image from said user, said second digital image comprising a reference item and a second scaling object of the same type and physical dimensions as the first scaling object;
scaling at least one of said first and second digital images such that the first and second scaling objects are of substantially equivalent dimensions in said first and second digital images;
causing said first and second digital images to be displayed, thus enabling the user to visually compare said selected item and said reference item based on said scaled at least one of said first and second digital images.

51. A computer system for facilitating online purchase of an item by a user, said computer system comprising:
memory for storing data and instructions for use by a processor; and
at least one processor coupled to said memory, wherein said at least one processor is programmed to:
retrieve a first digital image of an item selected by said user, said first digital image comprising a first scaling object;
obtain a second digital image from said user, said second digital image comprising a reference item and a second scaling object of the same type and physical dimensions as the first scaling object;
scale at least one of said first and second digital images such that the first and second scaling objects are of substantially equivalent dimensions in said first and second digital images; and
cause said first and second digital images to be displayed to said user, thus enabling said user to visually compare said selected item and said reference item based on said scaled at least one of said first and second digital images.

52. A computer program product comprising a computer-readable medium having a non-transitory computer program stored therein for facilitating online purchase of an item by a user, said computer program comprising:
computer program code means for retrieving a first digital image of an item selected by said user, said first digital image comprising a first scaling object;
computer program code means for obtaining a second digital image from said user, said second digital image comprising a reference item and a second scaling object of the same type and physical dimensions as the first scaling object;
computer program code means for scaling at least one of said first and second digital images such that the first and second scaling objects are of substantially equivalent dimensions in said first and second digital images;
computer program code means for causing said first and second digital images to be displayed, thus enabling the user to visually compare said selected item and said reference item based on said scaled at least one of said first and second digital images.
